(19) United States
(12) Patent Application Publication
(10) Pub. No.: US 2015/0323999 A1
(43) Pub. Date: Nov. 12, 2015

(54) INFORMATION INPUT DEVICE AND INFORMATION INPUT METHOD

(71) Applicant: SHIMANE PREFECTURAL GOVERNMENT, Matsue-shi (JP)

(72) Inventor: Kenji Izumi, Matsue-shi (JP)

(73) Assignee: SHIMANE PREFECTURAL GOVERNMENT, Matsue-shi (JP)

(21) Appl. No.: 14/274,923

(22) Filed: May 12, 2014

(51) Int. Cl. G06F 3/01; G06K 9/00

(52) U.S. Cl. CPC G06F 3/017; G06K 9/00355

(57) ABSTRACT

An information input device has: a display part; an area setting part for setting input instruction areas for an operator to give input instructions; an obtainment part for obtaining a situation of the operator to give the input instructions; and a control part for distinctively arranging a selection area and a decision area in input instruction areas in response to motions of both hands of the operator determined based on information on the obtained situation. The selection area is related to a partial area of an entire display area of a display part and for receiving a selecting operation by the operator in the partial area, and the decision area is for receiving a deciding operation by the operator.

### BACKGROUND OF THE INVENTION

1. Field of the Invention

The present invention relates to an information input device and an information input method, and more particularly, to an information input device and information input method for utilizing motions of operator's hands to perform input operations.

2. Description of the Related Art

In the past, there has been known an information input device that gives an input instruction to a computer by motions of an operator's hand and performs an input operation based on the input instruction. For example, Japan Patent Laid-Open No. 2004-078977 discloses a device that includes a CCD camera, a computer that recognizes the shape and the like of an object in an image imaged by the CCD camera, and a display for displaying the object recognized by the computer. The device is adapted to perform a selecting operation of a cursor on the display by motions of a user's hand.

Japan Patent Laid-Open No. 2004-258714 discloses a device that is adapted to perform, for example, a drag operation by motions of an operator's hand on a virtual plane.

### SUMMARY OF THE INVENTION

In the device disclosed in Japan Patent Laid-Open No. 2004-078977 or Japan Patent Laid-Open No. 2004-258714, a range of a target screen operated by motions of an operator's hand is large. However, in the situation where the range of the target screen to be operated is large, the motions of the operator's hand are not correctly recognized, and therefore the conventional devices may have a problem that it is not possible to appropriately move an object as a selecting object, such as a cursor, according to the motions of the hand.

In view of the above, it is an object of the present invention to provide an information input device and information input method, whereby motions of an operator's hand can be correctly recognized by narrowing a range of an operation target screen, and an operation on an object based on the motions of the hand can be appropriately performed.

To achieve the objects as described above, the information input device includes: a display part with a display area; an area setting part for setting input instruction areas for an operator to give input instructions; an obtainment part for obtaining a situation of the operator to give the input instructions; and a control part for distinctively arranging a selection area and a decision area in input instruction areas in response to motions of both hands of the operator determined based on information on the obtained situation, the selection area being related to a partial area of an entire display area of a display part and being for receiving a selecting operation by the operator in the partial area, and the decision area being for receiving a deciding operation by the operator.

Also, to achieve the objects as described above, the information input method includes: obtaining a situation where an operator gives input instructions; and distinctively arranging a selection area and a decision area in response to motions of both hands of the operator determined based on information on the obtained situation, the selection area being related to a partial area of an entire display area of a display part and being for receiving a selecting operation by the operator in the partial area, and the decision area being for receiving a deciding operation by the operator.

According to the present invention, by narrowing a range of an operation target screen, motions of an operator's hand can be correctly recognized, and an operation to be performed on an object on the basis of the motions of the hand can be appropriately performed.

Further features of the present invention will become apparent from the following description of exemplary embodiments with reference to the attached drawings.

### BRIEF DESCRIPTION OF THE DRAWINGS

FIG. 1 is a diagram showing an example of a schematic configuration of an information input device according to an embodiment of the present invention;

FIG. 2 is a diagram showing an example of a mode of input instructions given by an operator in the information input device of the embodiment;

FIG. 3 is a diagram showing an example of a locational relationship between selection and decision areas set in the case where an operator gives input instructions, when viewing the respective areas from the top;

FIG. 4 is a diagram showing the example of the locational relationship between the selection and decision areas set in the case where the operator gives the input instructions, when viewing the respective areas from the side;

FIGS. 5A and 5B are diagrams showing an example of a change mode of motions of hands in the case where the selection area and the decision area are interchanged;

FIGS. 6A and 6B are diagrams showing an example of an instruction mode by an operator in the case where a pointer displayed on a display device moves in response to to a motion of a finger in the selection area;

FIG. 7 is a diagram showing an example of a functional configuration of the information input device according to the embodiment;

FIG. 8 is a flowchart showing an example of the action of the information input device according to the embodiment;

FIG. 9 is a diagram showing a variation where the number of cameras equipped for the information input device is four; and

FIG. 10 is a diagram showing a variation that is adapted to set the selection area and the decision area on a desk surface.

### DESCRIPTION OF THE EMBODIMENTS

In the following, an information input device according to an embodiment of the present invention is described. The information input device according to the embodiment is a device that allows an operator to give input operations in response to motions of operator's hands.

### [Configuration of Information Input Device 1]

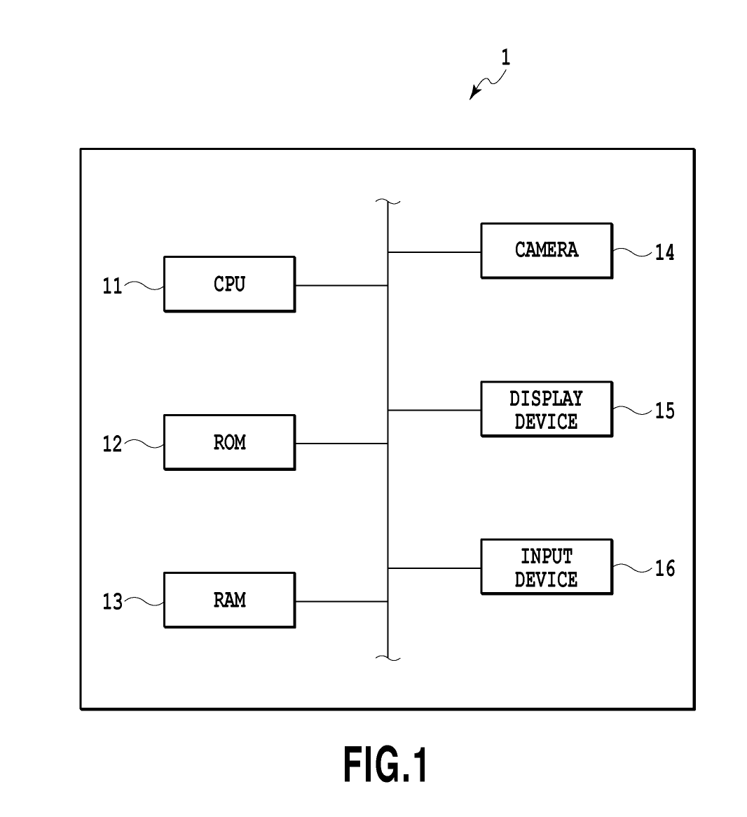

FIG. 1 is a diagram showing a hardware configuration example of the information input device 1 according to the embodiment of the present invention. As shown in FIG. 1, the information input device 1 has a CPU (Central Processing Unit) 11, ROM (Read Only Memory) 12, RAM (Random Access Memory) 13, camera 14, display device 15 and input device 16.

The CPU 11 is connected to the respective components through a bus to perform a transfer process of a control signal or data, as well as executing various types of programs for realizing the overall action of the information input device 1 and performing processes such as an arithmetic process.

The ROM 12 stores the programs and data necessary for the overall action of the information input device 1. These programs are stored on a storage medium such as a DVD-ROM, and read onto the RAM 13 to start the execution by the CPU 11, and thereby the information input device 1 of the present embodiment is realized.

The RAM 13 temporarily retains data or a program.

The camera 14 images a situation of input instructions given by an operator, and an image of the situation is transmitted to the CPU 11, where image recognition is performed. As will be described later, in the information input device 1 of this embodiment, the camera 14 images a two-dimensional or three-dimensional image for recognizing the input instructions given by the operator. However, as long as such imaging processing is possible, any system can be employed as a configuration of the camera 14. The camera 14 is a camera such as a camera with a CCD (Charge Coupled Device) sensor, a camera with a CMOS (Complementary Metal Oxide Semiconductor) sensor or an infrared camera.

The display device 15 can be a flat panel display such as a liquid crystal display or an EL (Electro-Luminescence) display.

The input device 16 includes, for example, a keyboard, mouse, operation buttons, touch panel, input pen, sensor and the like.

### [Outline of Input Instructions]

Next, the outline of the input instructions that are realized by the information input device 1 and given by an operator will be described.

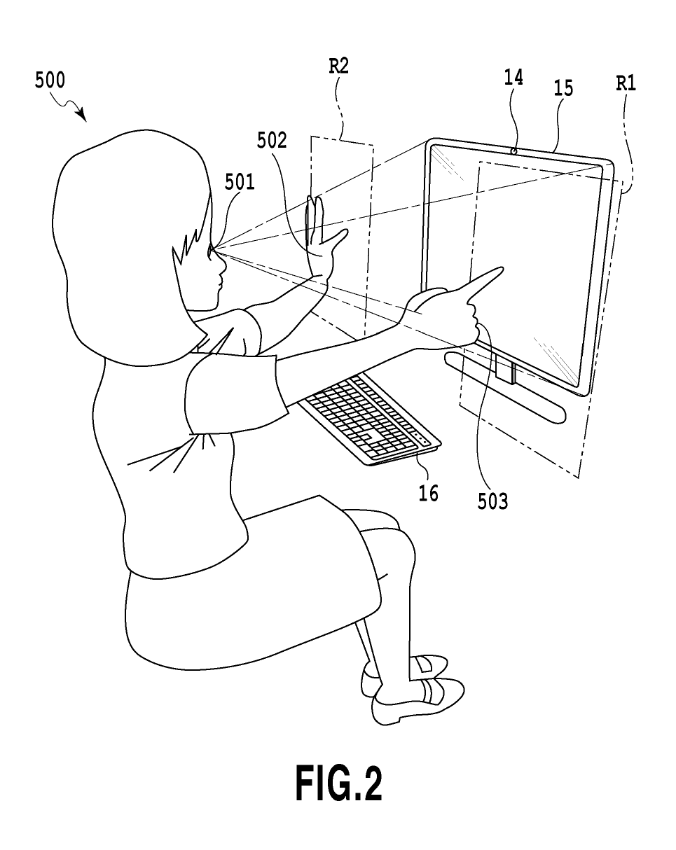

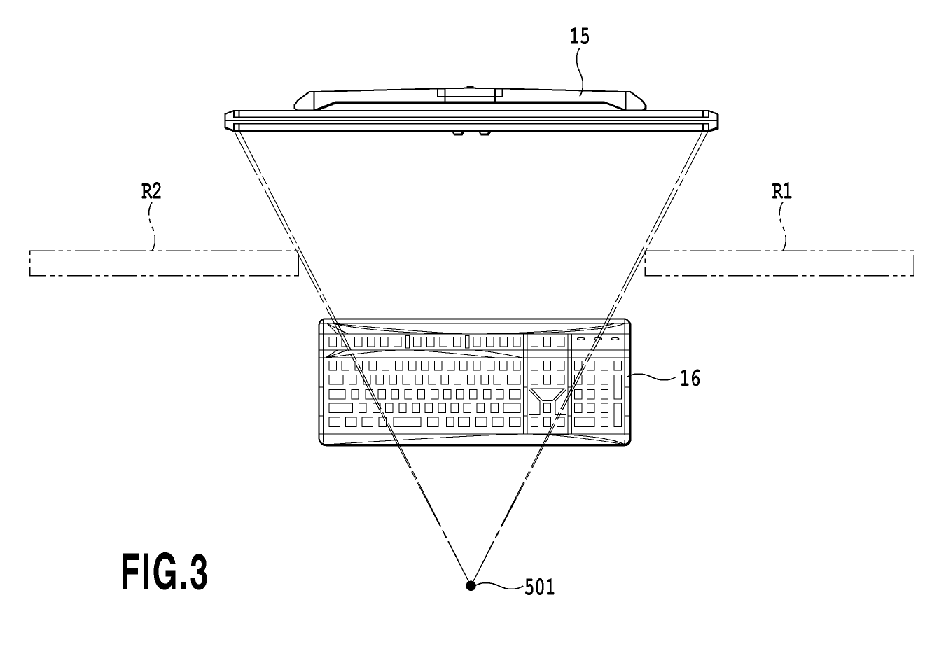

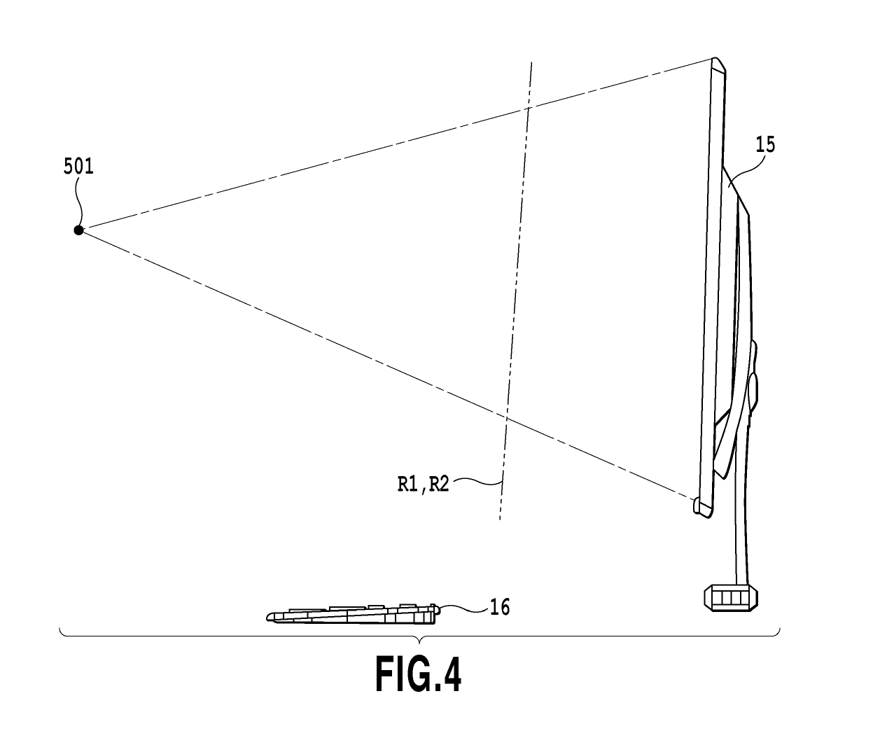

First, a mode of the input instructions by the operator will be described with reference to FIGS. 2 to 4. FIG. 2 is a diagram showing an example of the mode of the input instructions by the operator. FIG. 3 is a diagram showing an example of a locational relationship between a selection area and a decision area when viewing the respective areas from the top. FIG. 4 is a diagram showing the example of the locational relationship between the selection area and the decision area when viewing the respective areas from the side.

As shown in FIG. 2, in the information input device 1, the display device 15 is attached with the camera 14, and the camera 14 is configured to image a situation where the operator gives the input instructions, i.e., to image motions of the both hands 502 and 503 of the operator 500.

The information input device 1 is configured to recognize configurations of the fingers of the both hands 502 and 503 of the operator from an image imaged by the camera 14, and on the basis of a result of the recognition, distinctively arrange the selection area R1 and the decision area R2 as virtual input instruction areas.

A selecting operation is to give a selecting instruction on an object (such as an icon, pointer or cursor) displayed on the display device 15. A deciding operation is to give a deciding instruction such as clicking. The selecting operation and the deciding operation will be described later in detail.

For example, in the example of FIG. 2, the operator 500 opens the left hand 502 and raises the index finger of the right hand 503. In response to the configurations of the fingers of the operator 500, the CPU 11 arranges the selection area R1 for receiving a selecting operation by the operator 500 on the right hand 503 side, and the decision area R2 for receiving a deciding operation by the operator 500 on the left hand 502 side.

In the following description of the embodiment, a pattern of the shape of a hand with an index finger raised is referred to as a “pattern of the hand” for the selection area R1. In the information input device 1 of this embodiment, the pattern of a hand associated with the input instructions by the operator 500 causes the selection area R1 to be arranged on a side closer to the hand. Further, the decision area R2 is arranged on the side closer to the other hand. This means that every time the pattern of a hand for the selection area R1 is recognized by the CPU 11, the selection area R1 and the decision area R2 are interchanged and arranged, and in doing so, a selecting operation by the operator 500 is performed with, for example, an index finger raised.

The two areas shown in FIG. 2, i.e., the selection area R1 and the decision area R2 are arranged in the predetermined virtual input instruction areas. For example, as shown in FIGS. 2 to 4, the selection area R1 and the decision area R2 are both provided so as not to fall within a range (in FIGS. 2 to 4, indicated by alternate long and short dash lines) defined by connecting a viewpoint 501 of the operator and four corners of a display area of the display screen 15. Also, as shown in FIG. 3, the selection area R1 and the decision area R2 are arranged between the keyboard as the input device 16 and the display device 15. This enables the camera 14 to recognizably image motions of the both hands of the operator 500.

Locations where the selection area R1 and the decision area R2 are arranged are not limited to those described in the present example. It can be changed as long as a situation of the input instructions by the operator 500 can be recognizably imaged.

### [Interchange Process of Areas R1 and R2]

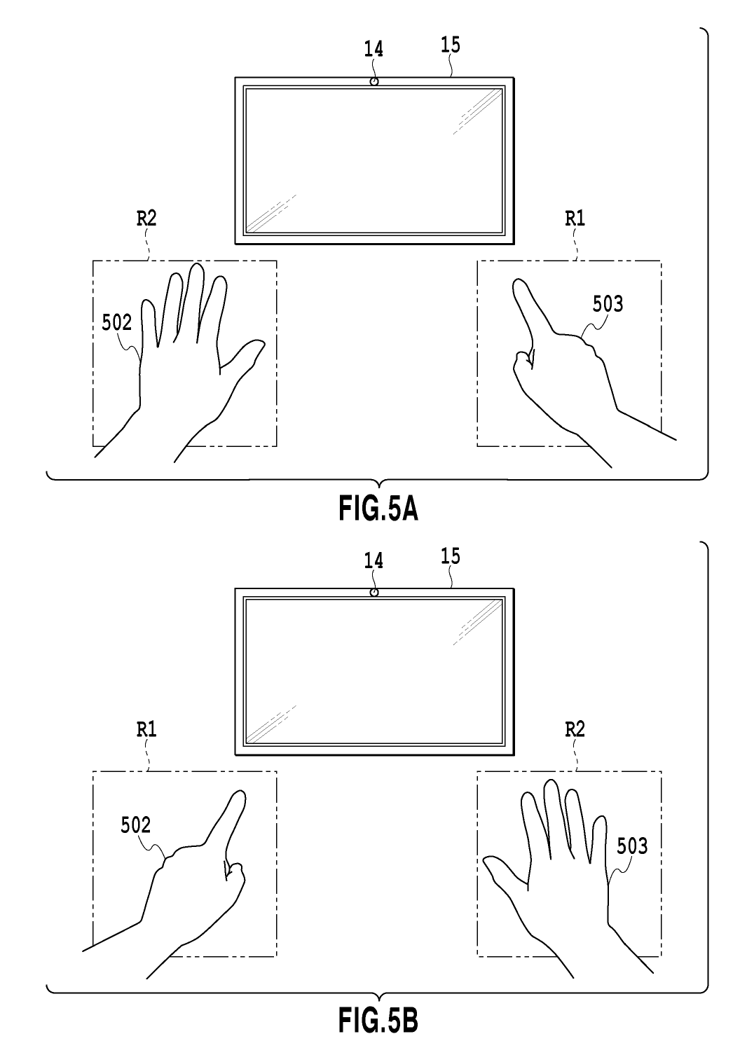

Next, motions of the hands of the operator 500 for interchanging the selection area R1 and the decision area R2 to arrange them will be described with reference to FIG. 5. FIG. 5 is a diagram showing an example of a change mode of motions of the hands 502 and 503 in the case where the selection area R1 and the decision area R2 are interchanged and arranged, in which FIG. 5A shows a situation of a selecting operation by the right hand 503 and FIG. 5B shows a situation of a selecting operation by the left hand 502.

In FIG. 5A or 5B, by raising an index finger of any of the hands, the selection area R1 is arranged on a side closer to the hand. In this example, the right hand 503 changes from a state where the index finger is raised to a state where the fingers are fully spread. The left hand 502 changes from a state where the fingers are fully spread to a state where the index finger is raised. In the information input device 1, according to the changes, the selection area R1 is arranged changed in location from the side closer to the right hand 503 to the side closer to the left hand 502. The decision area R2 is arranged changed in location from the side closer to the left hand 502 to the side closer to the right hand 503.

### [Selecting Operation by Operator in Selection Area R1]

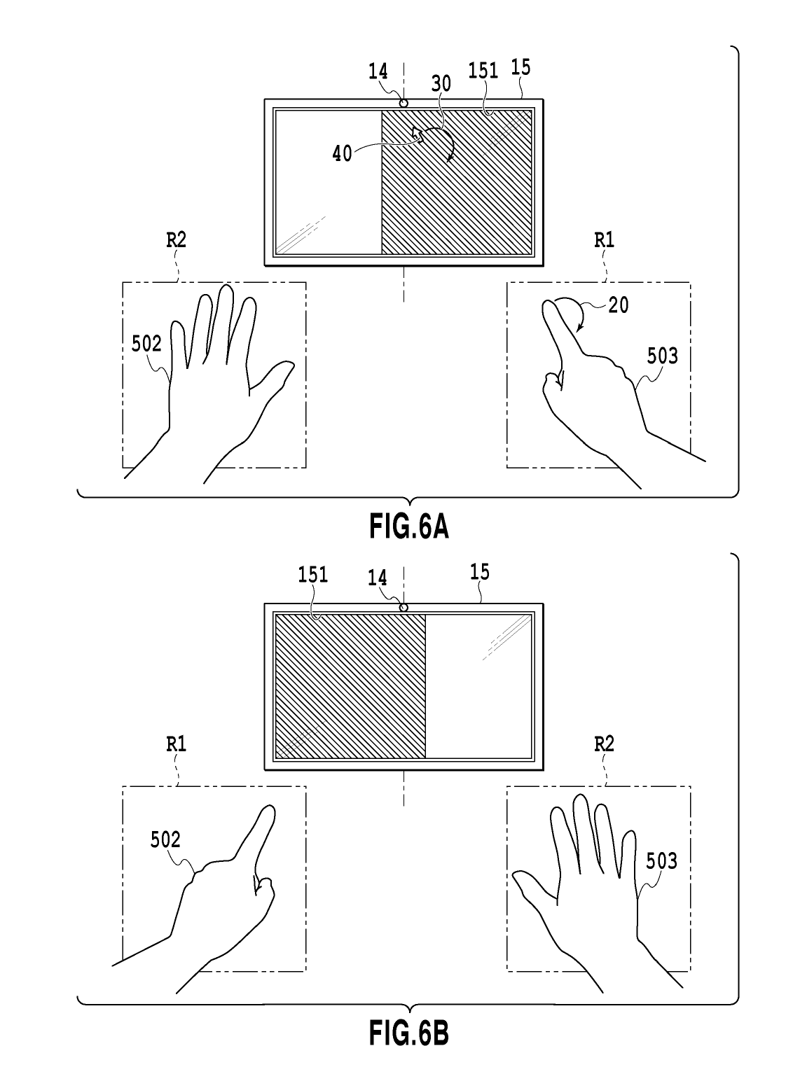

Next, a selecting operation by the operator 500 in the selection area R1 will be described with reference to FIG. 6. FIG. 6 is a diagram showing an example of an operation mode by the operator 500 in the case where a pointer 40 displayed on the display device 15 moves in response to a motion of the finger in the selection area R1, in which FIG. 6A shows a situation of a selecting operation by the right hand 503, and FIG. 6B shows a situation of a selecting operation by the left hand 503.

In FIG. 6A or 6B, the selection area R1 is related to a partial area 151 (in the figure, indicated by hatched lines) of the entire display area of the display device 15. In the information input device 1, the above-described area 151 is set so as be larger than an area obtained by evenly halving the display area along the centerline (in the figure, indicated by an alternate long and short dash line in the top-bottom direction) of the display area.

In the example of FIG. 6A, the selection area R1 is arranged on the right hand 503 side, and thus the partial area 151 related to the selection area R1 is set so as to include, for example, an area on the left side of the centerline (in the figure, indicated by the alternate long and short dash line in the top-bottom direction) of the display area. For the above reason, in the selection area R1, a display area where the operator 500 can perform a selecting operation is the area 151 shown in FIG. 6A.

Also, in FIG. 6A, solid lines indicated by reference numerals 20 and 30 indicate a situation where in the case of making a motion with the index finger of the right hand 502 in the selection area R1 according to the motion, the pointer 40 in the area 151 related to a position of the index finger 20, also moves. In doing so, the selecting operation in the selection area R1 can be realized.

On the other hand, the partial area 151 related to the selection area R1 shown in FIG. 6B is set so as to include an area on the right hand of the centerline (in the figure, indicated by the alternate long and short dash line in the top-bottom direction) of the display area.

The determination of the selecting operation in the selection area R1, shown in FIG. 6A or 6B, is made based on, for example, an image from the camera 14 having a viewing angle that is set so as to image the selection area R1 related to the area 151 shown in FIG. 6A or 6B. The relating between the selecting area R1 and the area 151 is performed using, for example, a mapping table for converting into coordinate data of the respective areas. For example, as shown in FIG. 6A, in the case where the operator 500 makes a motion with the index finger in the selection area R1, the CPU 11 determines the motion as a “selecting operation of the pointer 40” in the area 151, which is related to the position (coordinate data) in the selection area R1 indicated by the index finger. Then, the CPU 11 moves the pointer 40 in the area 151 along with the motion of the index finger in the selection area R1.

A range of the area 151 related to the selection area R1 is not limited to those described in the above example, but can be changed as long as the area 151 is set to meet the condition “area obtained by halving entire display area<area 151<entire display area”.

As described, in the information input device 1 of the present embodiment, in response to motions of the hands of the operator 500, the selection area R1 and the decision area R2 are interchanged and arranged, and therefore the operator 500 uses any of the hands to perform an appropriate selecting operation. This improves operability because the operator 500 gives a selecting instruction with a hand closer to an object (such as an icon) as a selecting object to thereby select the object, and consequently the selecting operation is more intuitively performed.

### [Deciding Operation by Operator in Decision Area R2]

Next, a deciding operation by the operator 500 in the decision area R2 will be described with reference to FIG. 2.

In the information input device 1, the operator 500 uses the left hand 502 to perform at least one predetermined motion in the decision area R2 shown in FIG. 2, and thereby the motion is determined as a correct deciding operation. Examples of the predetermined motion include cases such as the case where the left hand 502 is pushed out toward the display device 15, and the case where in the decision area R2, the left hand 502 changes like “open state→close state→open state”.

### [Functional Configuration of Information Input Device 1]

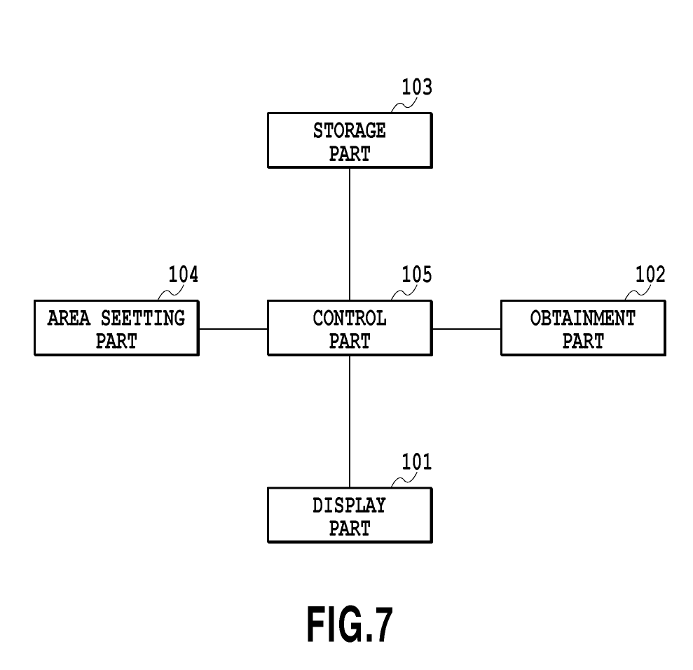

FIG. 7 is a diagram showing an example of a functional configuration of the information input device 1, which is realized based on the hardware configuration shown in FIG. 1.

As shown in FIG. 7, the information input device 1 is provided with a display part 101, obtainment part 102, storage part 103, area setting part 104 and control part 105.

The display part 101 is configured by the display device 15 in FIG. 1, and provided for making an object as a selecting object viewable to an operator.

The obtainment part 102 obtains a situation at the time when the operator gives the input instructions. In this embodiment, the obtainment part 102 is configured by, for example, the camera (imaging part) 14 in FIG. 1, and provided for imaging the situation at the time when the operator gives the input instructions. Note that the obtainment part 102 can also be applied with another configuration known to one having ordinary skill in the art, for example, a motion sensor that senses motions of the operator's hands, as long as the configuration makes it possible to obtain the situation at the time when the operator gives the input instructions.

The storage part 103 is configured by the ROM 12 and the RAM 13 in FIG. 1, and stores data.

The area setting part 104 and the control part 105 are functioned by the CPU 11. The area setting part sets the input instruction areas for the operator 500 to give the input instructions. The input instruction areas are virtual areas for arranging the above-described selection area R1 and decision area R2.

In response to motions of the both hands of the operator 500, which are determined on the basis of information on the situation obtained by the obtainment part 102, the control part 105 arranges the selection area R1, which is related to the partial area 151 of the entire display area of the display part 101 and intended to receive a selecting operation by the operator 500 in the area 151, and the decision area R2, which is intended to receive a deciding operation by the operator 500, distinctively in the input instruction areas. In this embodiment, as an example, the obtainment part 102 is configured as the camera 14, and therefore the control part 105 arranges the selection area R1 and the decision area R2 based on an image imaged by the camera 14, i.e., based on the situation information.

### [Action of Information Input Device 1]

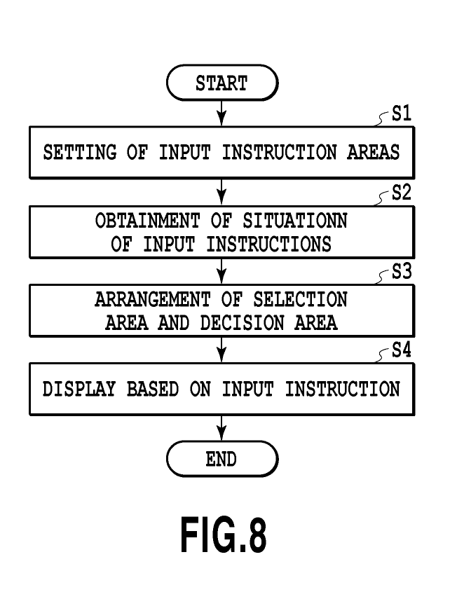

The action of the information input device 1 will be described below with reference to FIGS. 1, 2, and 6 to 8. FIG. 8 is a flowchart showing an example of the action of the information input device 1.

In FIG. 8, the CPU 11 (area setting part 104) of the information input device 1 sets the input instruction areas for the operator 500 to give the input instructions (S1). The input instruction areas are stored in the ROM 12 as, for example, pieces of coordinate data.

The camera (obtainment part 102) 14 images (obtains) a situation as shown in FIG. 2, i.e., a situation where the operator 500 gives the input instructions (S2).

The CPU 11 (control part 105) distinctively arranges the selection area R1 and the decision area R2 on the basis of an image (situation information) obtained by the camera 14. At this time, in the case where the CPU 11 determines that the pattern of a hand for the selection area R1 is present in the image, the CPU 11 arranges the selection area Ra on a side closer to the hand, and arranges the decision area R2 on the side closer to the other hand.

For example, in the example of FIG. 2, the selection area R1 is arranged in the input instruction area on the right hand 503 side, and the decision area R2 is arranged in the input instruction area on the left hand 502 side. The above-described selection area R1 is related to the partial area 151 of the entire display area of the display device 11 (see FIG. 6), and therefore the operator 500 in FIG. 2 performs a selecting operation in the area 151 shown in FIG. 6 with, for example, the right hand 503. As the selecting operation, FIG. 6A shows an example where the pointer 40 in the area 151 is moved by the motion of the index finger of the right hand 503.

Note that the locations of the respective areas R1 and R2 arranged in the input instruction areas are related to each other through, for example, coordinate data or the like.

The CPU 11 (control part 105) performs display based on an input instruction by the operator 500 (S4). For example, in the example of FIG. 6A, the pointer 40 is moved clockwise by the selecting operation on the pointer 40. In this case, the CPU 11 (control part 105) determines the selecting operation associated with the motion of the operator's index finger in the selection area R1 on the basis of the image from the camera 14 imaging the partial area 151 of the entire display area, and as a result, moves the pointer 40.

Note that, in FIG. 8, the CPU 11 (control part 105) may be adapted to, on the basis of the image from the camera 14, determine whether or not the motion corresponds to the pattern of a hand for the selection area R1, and in the case of determining that the motion corresponds to the pattern of a hand, interchange and arrange the selection area R1 and the decision area R2 (S3) to perform display based on an input instruction (S4). For example, FIGS. 6A and 6B show the example where the selection area R1 and the decision area R2 are interchanged and arranged by the motions of the both hands.

As described above, according to the information input device 1 of the present embodiment, the operator 500 makes motions with the hands to form the pattern of a hand for the selection area R1 with any of the hands, and thereby a selecting operation is performed. The selecting operation can be performed in the partial area of the entire display area, which is related to the selection area R1, and therefore the viewing angle of the camera 14 can be set so as to image the selection area R1. This enables the viewing angle of the camera 14 of the present embodiment to be narrowed, differently from a conventional one adapted to set a viewing angle so as to image an entire display area. Also, in the information input device 1, on the basis of an image from the above-described camera 14 having the narrowed viewing angle, a selecting operation by the operator 500 is determined, so that a target area for image recognition to recognize motions of the hands of the operator 500 is narrowed, and therefore accuracy of the image recognition is increased. For example, in the case where the display device 15 is a horizontally wide display (such as a display having an aspect ratio (horizontal to vertical ratio) of 16:9), an area for a gesture operation to be subjected to image recognition can be narrowed, and therefore the information input device 1 can increase recognition accuracy of an image obtained from the camera 14. In other words, the information input device 1 can more accurately recognize motions of the hands of the operator 500. Accordingly, a selecting operation by the operator 500 can be more accurately performed.

Also, in the information input device 1 of the present embodiment, the selection area R1 is related to the partial area 151 of the entire display area, and therefore a gesture operation by the operator 500 can move, for example, the pointer 40 in the partial area 151 of the entire display area. At this time, a recognition result based on an image obtained from the camera 14 can be reflected in an operation of the pointer 40 not in the entire display area but with a focus on the partial area 151. For this reason, in the information input device 1, an operation to be performed on an object on the basis of a gesture operation by the operator 500 can be appropriately performed.

Further, pointing a selecting object, and gesture as a deciding operation may be performed with the left and right areas interchanged, and therefore a motion of only one hand of the operator 500 can be prevented. For this reason, in addition to achieving a reduction in physical fatigue, a pointing operation can be performed with a hand/finger closer to a pointing object.

Further, by limiting an area related to the selection area R1 to the part of the entire display area, the selection area R1 is made less likely to enter the visual field of the operator 500. Accordingly, the camera 14 can more easily image the shapes of the hands of the operator 500, and therefore the information input device 1 can more easily performs image recognition. Further, the viewing angle of a camera 14 to be equipped can be limited to a necessity minimum, and therefore a common camera for purposes such as a camera conference, which is not wide-angle, can be used.

Next, variations of the information input device 1 of the present embodiment will be described.

### (First Variation)

In the foregoing, the case of using the one camera 14 to image the situation where the operator gives the input instructions is described with reference to FIG. 2. However, the present invention may be adapted to provide a plurality of cameras.

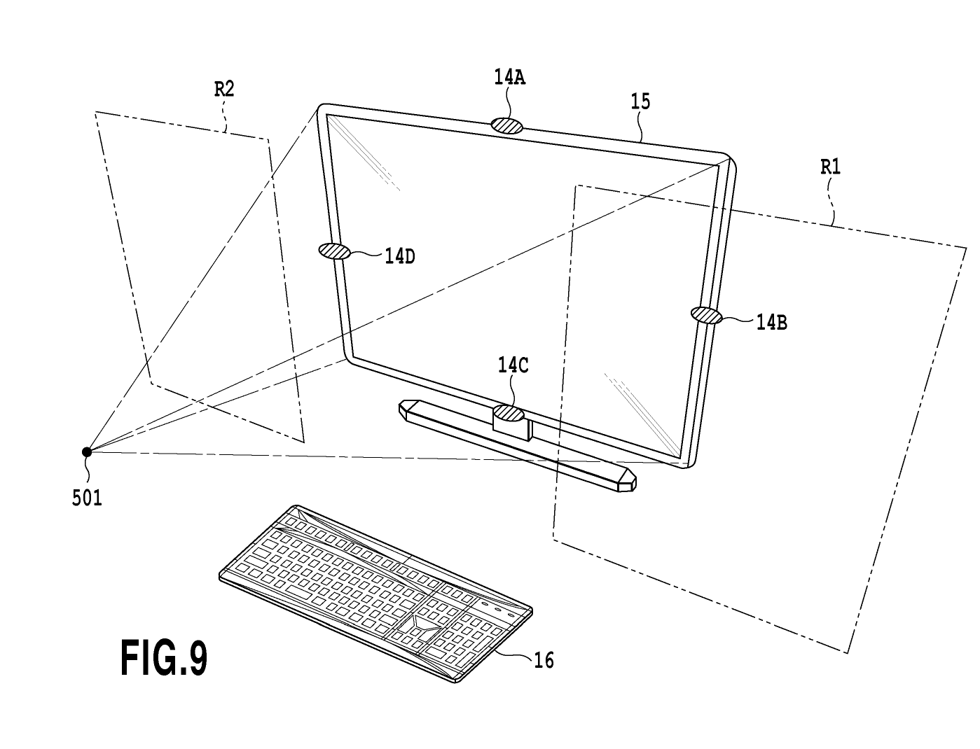

FIG. 9 is a diagram showing a variation where the number of cameras equipped for the information input device 1 is four. In the example of FIG. 9, the four cameras 14A, 14B, 14C, and 14D are attached to the display device 15. By configuring the information input device 1 as described, the accuracy of image recognition can be increased.

### (Second Variation)

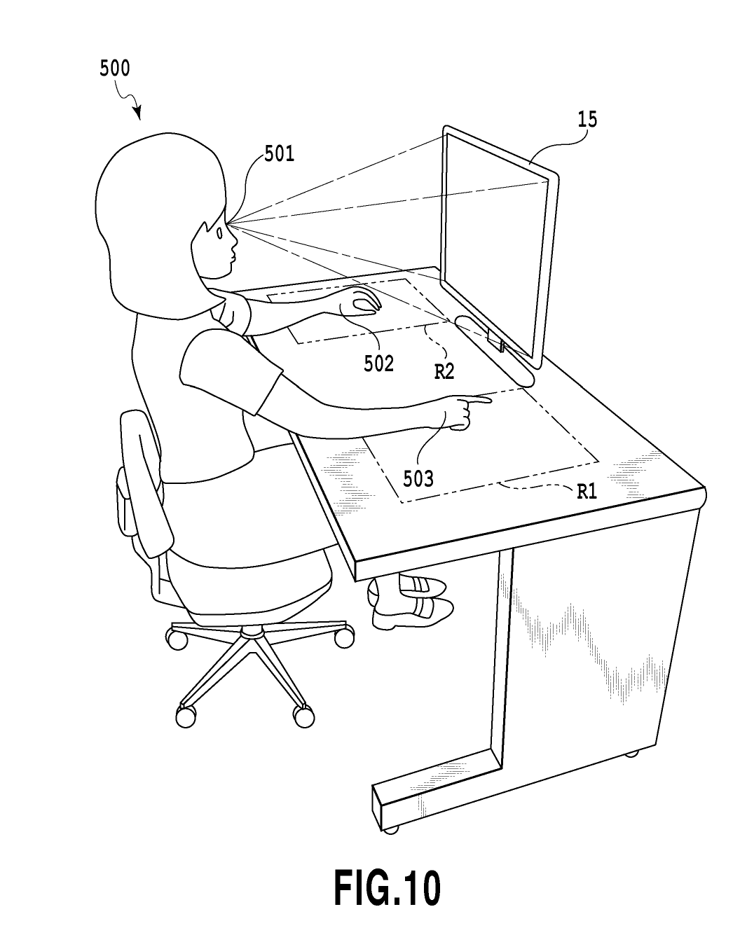

The locations of the selection area R1 and the decision area R2 can be freely set. For example, FIG. 10 shows a variation adapted to set the selection area R1 and the decision area R2 on a desk surface. In doing so, a load on the input instructions by the hands of the operator 500 is reduced.

### (Third Variation)

The pattern of a hand for the selection area R1 can be changed. The present invention can also be adapted to, for example, raise a thumb, or bring a hand into a close state.

### APPENDIX 1

An information input device including:

a display part with a display area;

an area setting part for setting input instruction areas for an operator to give input instructions;

an obtainment part for obtaining a situation of the operator to give the input instructions; and

a control part for distinctively arranging a selection area and a decision area in input instruction areas in response to motions of both hands of the operator determined based on information on the obtained situation, the selection area being related to a partial area of an entire display area of a display part and being for receiving a selecting operation by the operator in the partial area, and the decision area being for receiving a deciding operation by the operator.

### APPENDIX 2

The information input device according to appendix 1, wherein the control part interchanges and arranges the selection area and the decision area in response to patterns of the fingers of the operator, the patterns being recognized from changes in the motions of the both hands of the operator.

### APPENDIX 3

The information input device according to appendix 1 or 2, wherein the partial area is set so as to be larger than an area obtained by evenly halving the display area along a centerline of the display area.

### APPENDIX 4

The information input device according to any one of appendices 1 to 3, wherein when the obtainment part is an imaging part for imaging the situation of the operator, the imaging part is configured to set a viewing angle so as to image the selection area related to the partial area, and obtain an imaged image as the information on the situation, and

the control part is configured to determine the selecting operation by the operator in the selection area based on the image from the imaging part.

### APPENDIX 5

An information input method including:

obtaining a situation where an operator gives input instructions; and

distinctively arranging a selection area and a decision area in response to motions of both hands of the operator determined based on information on the obtained situation, the selection area being related to a partial area of an entire display area of a display part and being for receiving a selecting operation by the operator in the partial area, and the decision area being for receiving a deciding operation by the operator.

### APPENDIX 6

The information input method according to appendix 5, wherein in the arranging step, the selection area and the decision area are interchanged and arranged in response to patterns of the fingers of the operator, the patterns being recognized from changes in the motions of the both hands of the operator.

### APPENDIX 7

The information input method according to appendix 5 or 6, wherein the partial area is set so as to be larger than an area obtained by evenly halving the display area along a centerline of the display area.

### APPENDIX 8

A program for causing a computer to perform the information input method according to any one of appendices 5 to 7.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information input device comprising:
a display part with a display area;
an area setting part for setting input instruction areas for an operator to give input instructions;
an obtainment part for obtaining a situation of the operator to give the input instructions; and
a control part for distinctively arranging a selection area and a decision area in input instruction areas in response to motions of both hands of the operator determined based on information on the obtained situation, the selection area being related to a partial area of an entire display area of a display part and being for receiving a selecting operation by the operator in the partial area, and the decision area being for receiving a deciding operation by the operator.

2. The information input device according to claim 1, wherein the control part interchanges and arranges the selection area and the decision area in response to patterns of the fingers of the operator, the patterns being recognized from changes in the motions of the both hands of the operator.

3. The information input device according to claim 1, wherein the partial area is set so as to be larger than an area obtained by evenly halving the display area along a centerline of the display area.

4. The information input device according to claim 1, wherein when the obtainment part is an imaging part for imaging the situation of the operator,
the imaging part is configured to set a viewing angle so as to image the selection area related to the partial area, and obtain an imaged image as the information on the situation, and
the control part is configured to determine the selecting operation by the operator in the selection area based on the image from the imaging part.

5. An information input method comprising:
obtaining a situation where an operator gives input instructions; and
distinctively arranging a selection area and a decision area in response to motions of both hands of the operator determined based on information on the obtained situation, the selection area being related to a partial area of an entire display area of a display part and being for receiving a selecting operation by the operator in the partial area, and the decision area being for receiving a deciding operation by the operator.

6. The information input method according to claim 5, wherein in the arranging step, the selection area and the decision area are interchanged and arranged in response to patterns of the fingers of the operator, the patterns being recognized from changes in the motions of the both hands of the operator.

7. The information input method according to claim 5, wherein the partial area is set so as to be larger than an area obtained by evenly halving the display area along a centerline of the display area.

8. A storage media recording a program for causing a computer to perform an information input method, the information input method comprising:
obtaining a situation where an operator gives input instructions; and
distinctively arranging a selection area and a decision area in response to motions of both hands of the operator determined based on information on the obtained situation, the selection area being related to a partial area of an entire display area of a display part and being for receiving a selecting operation by the operator in the partial area, and the decision area being for receiving a deciding operation by the operator.

9. The information input device according to claim 2, wherein the partial area is set so as to be larger than an area obtained by evenly halving the display area along a centerline of the display area.

10. The information input device according to claim 2, wherein when the obtainment part is an imaging part for imaging the situation of the operator,
the imaging part is configured to set a viewing angle so as to image the selection area related to the partial area, and obtain an imaged image as the information on the situation, and
the control part is configured to determine the selecting operation by the operator in the selection area based on the image from the imaging part.

11. The information input device according to claim 3, wherein when the obtainment part is an imaging part for imaging the situation of the operator,
the imaging part is configured to set a viewing angle so as to image the selection area related to the partial area, and obtain an imaged image as the information on the situation, and
the control part is configured to determine the selecting operation by the operator in the selection area based on the image from the imaging part.

12. The information input method according to claim 5, wherein the partial area is set so as to be larger than an area obtained by evenly halving the display area along a centerline of the display area.

13. An information input device comprising:
a display device with a display area;
at least one CPU coupled to the display device, wherein the at least one CPU is configured to:
set input instruction areas for an operator to give input instructions;
obtain a situation of the operator to give the input instructions; and
distinctively arrange a selection area and a decision area in input instruction areas in response to motions of both hands of the operator determined based on information on the obtained situation, the selection area being related to a partial area of an entire display area of a display part and being for receiving a selecting operation by the operator in the partial area, and the decision area being for receiving a deciding operation by the operator.
